(19) United States
(12) Patent Application Publication
(10) Pub. No.: US 2006/0016945 A1
(43) Pub. Date: Jan. 26, 2006

(54) Portable podium

(76) Inventor: Elton Taylor, Marshall, TX (US)

Correspondence Address: LITMAN LAW OFFICES, LTD, PO BOX 15035, CRYSTAL CITY STATION, ARLINGTON, VA, 22215, US

(21) Appl. No.: 11/184,826

(22) Filed: Jul. 20, 2005

Related U.S. Application Data
(60) Provisional application No. 60/589,595, filed on Jul. 21, 2004.

(51) Int. Cl. F16M 11/26; A47G 29/00

(52) U.S. Cl. 248/188.5; 248/371

(57) ABSTRACT

The adjustable, portable podium includes a podium top or rack having a tray, the rack being pivotally connected with a telescoping support of nested tubing by a securing bolt, allowing the angle of the podium to be adjusted. The nested tubing is preferably of three, 16-inch lengths having wing screws for locking in an extended position, and which can be loosened to collapse the tubing to a retracted position. A base has a centrally disposed, externally threaded connector extending upward to receive the lower end of the nested tubing in a lower wall thereof. A carrying case is provided for easy transport of the collapsed podium. The podium is easily assembled and can be adjusted to the user's height, whether standing or sitting.

### CROSS-REFERENCE TO RELATED APPLICATION

This application claims the benefit of U.S. Provisional Patent Application Ser. No. 60/589,595, filed Jul. 21, 2004.

### BACKGROUND OF THE INVENTION

1. Field of the Invention

The present invention relates to portable podiums. More particularly, the present invention relates to an adjustable, collapsible podium and carrying case.

2. Description of the Related Art

The use of podiums for delivering speeches and sermons and for holding music for musicians is well known. They are useful for holding materials when delivering the speech or during a musical performance. Many lecturers, preachers, and musicians travel from location to location for delivery of the speech or sermon or to perform, and an appropriate podium may not be available at a particular site. If a podium is available, it may be a fixed podium at the wrong height for a particular individual. It would be desirable to provide a podium which is both adjustable in height, angle or podium surface, which is collapsible, and which may be easily disassembled into parts, stored in a carrying bag, and reassembled and adjusted at a new location. Such a podium should be light in weight, yet stable during use.

U.S. Pat. No. 5,615,620, issued Apr. 1, 1997 to Owen, describes a portable desk having a base plate securable to a vehicle floorboard by conventional fasteners, such as bolts or screws. A centrally disposed fixed cylindrical pedestal extends upwardly from the base plate into an open bottom end of a tubular vertical support column. A first setscrew secures the support column in a rotationally and vertically adjusted position on the pedestal. A mounting standard includes a straight lower leg portion secured in a telescopically adjusted position within an open upper end of the vertical support column by a second setscrew. A toggle clamping screw in conjunction with a pivotal mounting bracket adjustably secures a support platform to an upper end of the mounting socket. A desk surface may be secured to the support platform by conventional fasteners, such as screws. The portable desk may be used with the desk surface in a vehicle, or detached from the pedestal and secured to a conventional microphone stand or other support for use as a portable podium at oral presentations.

U.S. Patent Publication No. 2002/0066630, published Jun. 6, 2002, for Brown, Sr., describes a multi-configurable portable desk or table companion that is adjustable to permit it to be folded for transport and configured to one of a desk state, podium state, easel state, music stand, or artist table state. The desk companion can also be used to support a laptop computer. The multi-configurable portable desk companion includes two arm members angularly adjustable via a lever-operated adjustment clamp and a multi-positionable desktop surface angularly adjusted by a lever-operated adjustment clamp. The two arm members are coupled to a collapsible tripod leg assembly to vary the height of the multi-positionable desktop surface.

U.S. Pat. No. 5,713,553, issued Feb. 3, 1998 to Cooper, describes a combination stand and rack releasably secured atop the stand. The stand is convertible between an extended use position and a collapsed storage position. The rack includes a hollow spine for storage of the stand in the collapsed storage position. The stand comprises a main telescopic post and a plurality of support legs, all of which are secured to a common housing. The main post extends upwardly from the housing and the legs are attached to the housing by connectors, which are bendable through an angle of more than 90°, such that the legs fold upwardly beside the main post in the storage position and unfold downwardly from the housing to the use position.

U.S. Pat. No. 2,567,594, issued Sep. 11, 1951 to Bemis, describes a display stand having an adjustable tilting upper surface and a telescoping support. U.S. Pat. No. 4,982,820, issued Jan. 8, 1991 to Scott, describes a collapsible display stand contained in a travel case which has a telescoping support employing spring-loaded fastening devices for supporting the telescoping portions in the open position.

None of the above inventions and patents, taken either singly or in combination, is seen to describe the instant invention as claimed. Thus a portable podium solving the aforementioned problems is desired.

### SUMMARY OF THE INVENTION

The portable podium of the present invention includes a podium top or rack having a tray connected with a telescoping support of nested tubing by a securing wing bolt, allowing the angle of the podium to be adjusted. The nested tubing is preferably of three 16-inch lengths having wing screws for locking in an extended position, and which can be loosened to collapse the tubing to a retracted position. A base has a centrally disposed, externally threaded connector extending upward to receive the lower end of the nested tubing in a lower wall thereof. A carrying case is provided for easy transport of the collapsed podium. The podium is easily assembled and can be adjusted to the user's height, whether standing or sitting.

These and other features of the present invention will become readily apparent upon further review of the following specification and drawings.

### BRIEF DESCRIPTION OF THE DRAWINGS

FIG. 1 is a perspective view of a portable podium according to the present invention.

FIG. 2 is an exploded view of the portable podium of FIG. 1.

FIG. 3 is a side elevation view of the portable podium of FIG. 1.

FIG. 4 is a front perspective view of a carrying case for the disassembled portable podium of FIG. 1.

FIG. 5 is a front perspective view of the carrying case of FIG. 4 with the straps disconnected and the flap raised to expose storage pockets.

Similar reference characters denote corresponding features consistently throughout the attached drawings.

### DETAILED DESCRIPTION OF THE PREFERRED EMBODIMENT

The present invention is a portable podium that may be disassembled into its component parts and carried in a case. The component parts include a podium rack having support flanges which attaches to the upper portion of adjustable nested support tubes, and a base.

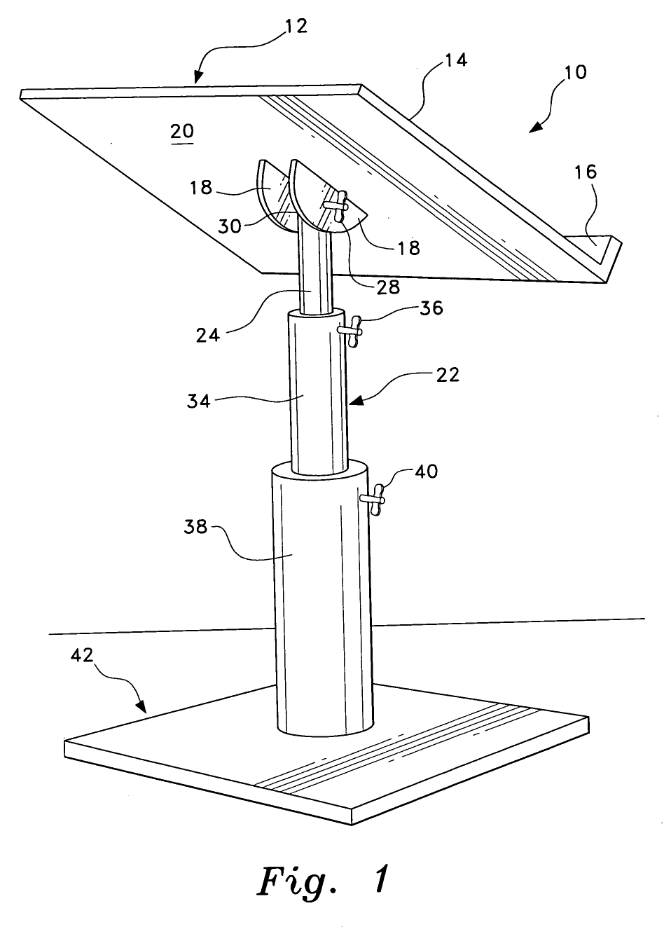

Referring to the FIGS. 1-3, the portable podium of the present invention is referred to by reference number 10 and includes a podium rack 12 supported by an adjustable vertical nested support 22 and a podium base 42. Portable podium rack 12 has a back plate 14 with a tray flange 16 at its base for holding papers or the like. Rack back plate 14 is mounted on first and second support flanges 18 in the central portion of the back plate rear surface 20. Adjustable vertical support 22 is made up of adjustable nesting tubes, including upper support tube 24, central support tube 34, and lower support tube 38. Back plate mounting support flanges 18 are releasably attached to the upper end portion 30 of upper support tube 24, and podium rack 12 is adjustably held at a desired angle relative to vertical support 22, by securing wing bolt 28.

The overall height of the vertical support 22 is adjusted by adjusting the location of upper support tube 24 within central support tube 34 and by adjusting the location of central support tube 34 within lower support tube 38. Upper support tube 24 is secured at a desired height by upper adjustment wing screw 36 in the upper portion of central support tube 34, and central support tube 34 is secured at a desired height by lower adjustment wing screw 40 in the upper portion of lower support tube 38. Lower support tube 38 is supported on podium base 42.

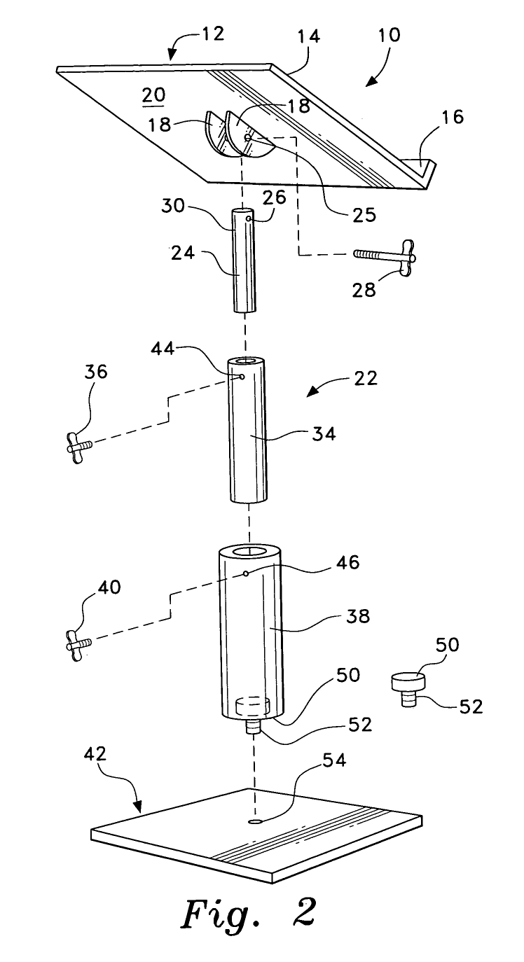

As seen in the exploded view of FIG. 2, the upper portion 30 of upper nesting support tube 24 has opposed securing bolt receiving bores 26 corresponding with aligned flange receiving bores 25 within back plate mounting support flanges 18 in order to receive rack mounting securing wing bolt 28 for pivotal rotation therearound. The second back plate mounting support flange 18 has a threaded receiving bore 25. The rack mounting securing wing bolt 28 is inserted through the first support flange 18, through receiving bores 26 of upper support tube 24, and then fastened within the threaded receiving bore 25 in the second support flange 18. The angle of the podium rack 12 may then be adjusted by rotating the securing wing bolt 28 to loosen the podium rack 12, rotating the rack 12 to the desired angle, and tightening the wing bolt 28 in the threaded receiving bore 25 of the second support flange 18, thus maintaining the podium rack 12 in the adjusted position.

Central adjustment wing screw 36 is inserted into upper threaded bore 44 of central support tube 34 to impinge on upper support tube 24 at a desired height, thereby locking the upper support tube 24 in position. Likewise, lower adjustment wing screw 40 is inserted into lower threaded bore 46 of lower support tube 38 so as to impinge on central support tube 34 at a desired height. Vertical support 22 has a lower wall 50 formed at the base of lower support tube 38 having an axially mounted vertical support stud 52 extending downward to be received by internally threaded stud receiver 54 centrally located on podium base 42.

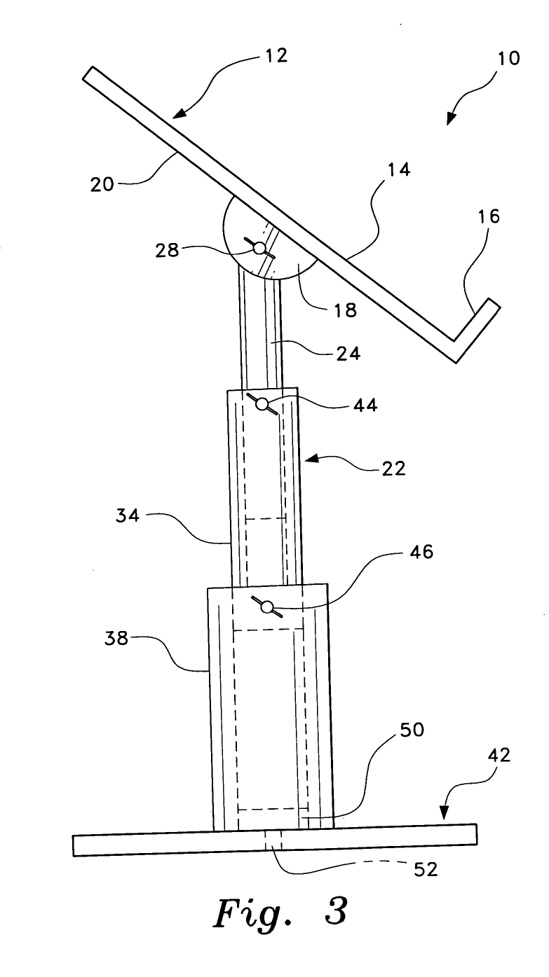

FIG. 3 shows a side elevation view of the assembled portable podium 10 illustrating the podium rack 12 as held by back plate mounting support flanges 18 which are adjustably fastened to the upper portion of adjustable vertical support 22 by wing bolt 28 which, in turn, is supported by vertical support stud 52. The lower portions of upper nesting support tube 24 and central nesting support tube 20 are shown in hidden lines adjusted to a desired height (upper and lower adjustment screws are not shown). Vertical support lower wall 50 and vertical support stud 52 are shown in hidden lines.

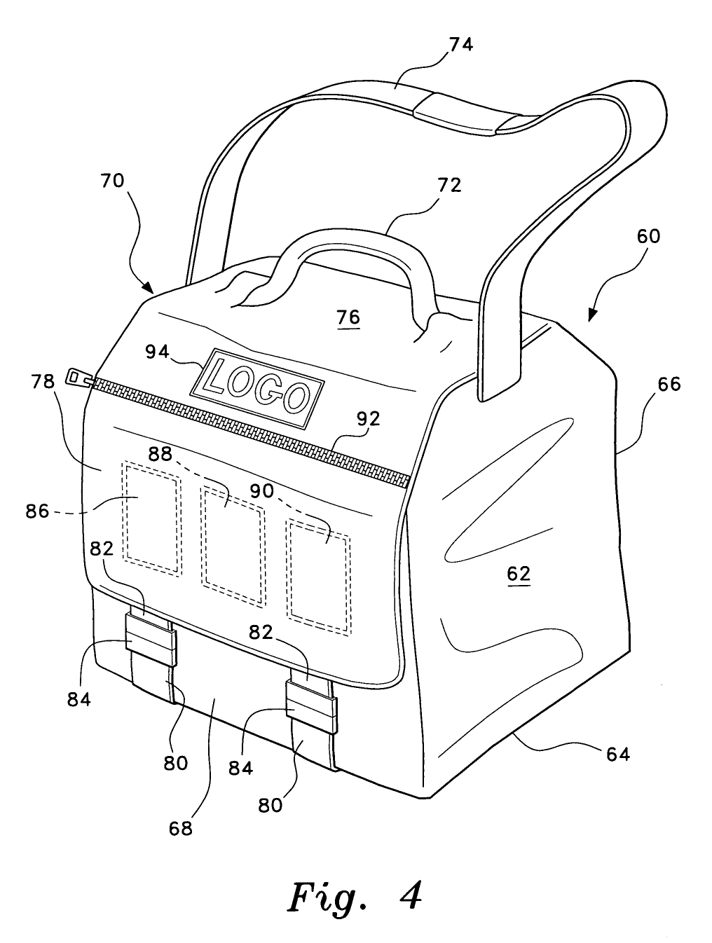

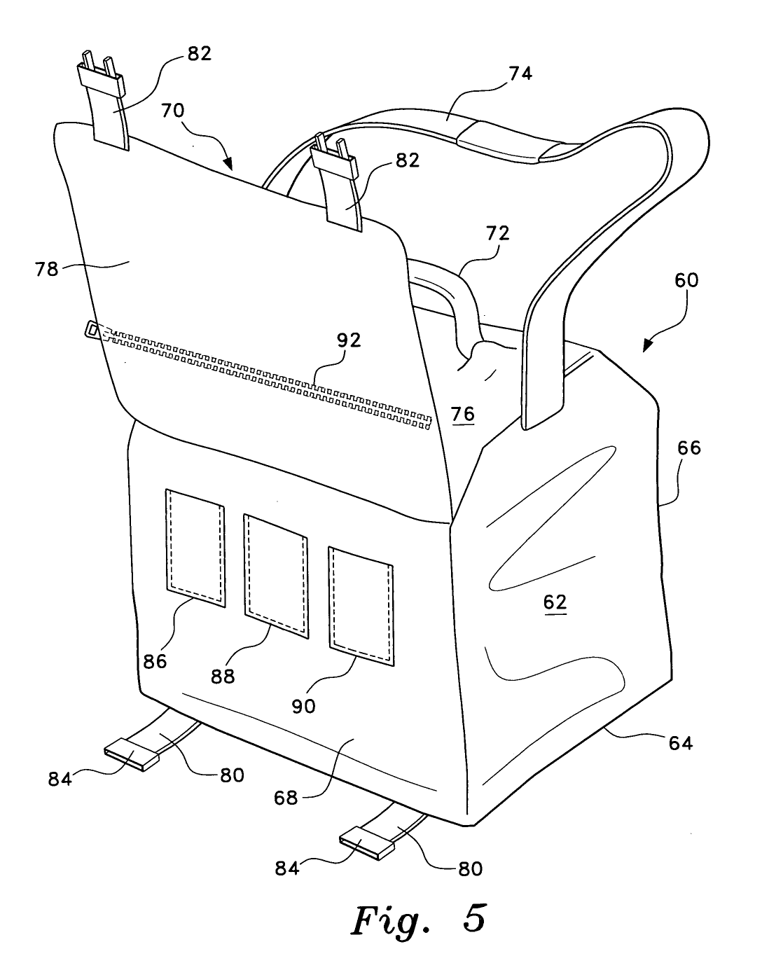

Referring to FIGS. 4 and 5, there is shown a carrying case 60 for carrying the disassembled portable podium 10. Carrying case 60 has sidewalls 62, a bottom wall 64, a rear wall 66, a front wall 68, and upper cover/flap 70. A handle strap 72 is attached to upper cover portion 76, and a shoulder strap 74 is attached at opposite ends to the upper portions of sidewalls 62, respectively. Front flap 78 is connected with the front wall 68 at bottom wall 64 by upper straps 82 and lower straps 80 fastened by strap connecting snaps 84. As seen in FIG. 5, front flap 78 and upper cover 70 may be opened by disconnecting strap snaps 84 revealing storage pockets 86, 88, and 90. Front flap 78 may form a pocket opened by zipper 92. A logo 94 or other identification may be placed anywhere on the bag 60, such as on the upper cover portion 76 above zipper 92. Bag 60 may be made of leather or other appropriate material, and other types of fasteners may be used in place of snaps 84.

The portable podium 10 is assembled by assembling the nesting support tubes 24, 34, and 38 and tightening the wing screws 56 and 58. The adjustable vertical support thus formed is screwed into the podium base 42. Podium rack back plates 18 are placed over the upper end 30 of upper support tube 24 such that bores 25 and 26 are aligned and securing wing bolt 28 inserted therethrough. Securing wing bolt 28 engages the threaded bore of second back plate 18 and is turned to a snug position against the support tube 24. The height of the podium may then be adjusted by individually loosening wing screw 36 and 40, pulling upward or pushing downward on the appropriate support tube, and then tightening the wing screws to secure the upper rack podium rack 12 at the desired height. The angle of the rack 12 may then be adjusted by loosening securing wing bolt 28, rotating podium rack 12 to the desired angle, and then tightening securing wing bolt 28.

The portable podium of the present invention may be made of appropriate materials such as aluminum. Although the nesting support tubes are shown as cylindrical, any nesting wall shape may be employed in the invention, such as square tubes. Although the sections of vertical support 22 are shown secured by wing screws 36 and 40 clamped against the wall of the inner tube, it will be understood that any means known in the art for temporarily clamping or locking telescoping tubes together may be substituted for wing screws 36 and 40. The vertical support segments 24, 34 and 38 may be any desired length. An exemplary dimension is sixteen inches, which would allow the portable podium 10 to be adjustable in height for any use from tabletop through a freestanding position.

It is to be understood that the present invention is not limited to the embodiment described above, but encompasses any and all embodiments within the scope of the following claims.

I claim:

1. An adjustable, portable podium, comprising:
a base;
an adjustable height vertical support having a plurality of nested, telescoping sections, the vertical support being detachably mounted on said base;
at least one wing screw for temporarily locking the telescoping sections in order to selectively fix the height of the vertical support; and
a podium rack having a back plate and a tray flange extending from an edge of the back plate, the podium rack being detachably and pivotally mounted to the vertical support;
whereby the base, the vertical support, and the podium rack are disassembled for transport and the podium rack is extendable in height and angle.

2. The adjustable, portable podium of claim 1, further comprising a carrying case, the base, the vertical support, and the podium rack being disassembled and disposed within the carrying case for storage and transport.
